(19) United States
(12) Patent Application Publication
(10) Pub. No.: US 2013/0271487 A1
(43) Pub. Date: Oct. 17, 2013

(54) POSITION LAG REDUCTION FOR COMPUTER DRAWING

(71) Applicant: Jan Staffan Lincoln, Lund (SE)

(72) Inventor: Jan Staffan Lincoln, Lund (SE)

(73) Assignee: RESEARCH IN MOTION LIMITED, Waterloo (CA)

(21) Appl. No.: 13/444,029

(22) Filed: Apr. 11, 2012

(51) Int. Cl. G09G 5/00; G06F 3/033

(52) U.S. Cl. 345/619; 345/157

(57) ABSTRACT

The present disclosure provides a computer drawing system having reduced position lag. A sequence of first and second position coordinates of a drawing tool position is received and, from them, a future position of the drawing tool of the drawing tool is predicted. An image frame is produced dependent upon the predicted position of the drawing tool and is output for rendering on a display screen. Similarly, the image frame may be dependent upon a predicted trajectory of the drawing tool.

### BACKGROUND

In a computer drawing application, images on a screen are controlled by a drawing tool such as, for example, a stylus, finger, or computer mouse. A stylus is a pen-like computer input device that provides position input to an application program executing on a host electronic device. The position of the stylus may be determined by any of a variety of techniques. Similarly, a finger may be used as a drawing tool on touch screens such as resistive or capacitive touch screens.

Often, the tip of the stylus or a finger is moved over the surface of a display screen and the host electronic device renders an image by adjusting pixel values in the neighborhood of the tip of the stylus or the finger. The position of the input device as it moves relative to the screen is sampled at regular intervals, and a plurality of program instructions must be executed on the processor of the host electronic device before pixel values dependent on the position information can be determined to enable a complete frame of pixels to be formed. In addition, display drivers, such as computer graphics circuits, often buffer completed frames. The combination of computation and buffering delays introduces a time delay between a current position of the drawing tool and the actual image rendered on the screen.

This buffering process introduces a time lag that may be unimportant for some computer operations such as animations, which don't utilize real-time input. However, when displaying an image controlled by a computer drawing tool, the use of a frame buffer introduces a mismatch, or position lag, because the image on the screen lags the position of the drawing tool on the screen. FIG. 1 is a diagram of a known drawing system. Referring to FIG. 1, a drawing tool 100 is moved, by a user 12, across the surface of a display screen 108. The drawing tool may be used to cause a line 106 to be rendered on the display screen 108, the line 106 following the trajectory of the drawing tool 100. The tip of the drawing tool 100 is at a position 14 on the screen 108. However, because of the position lag, the rendered line 106 ends at a position 16, approximately corresponding to the position of the drawing tool 100 at the earlier time. The rendered line 106 lags the position of the stylus 100. This position lag increases with the speed of the stylus 100.

This delay may be reduced by sampling more often, reducing the processing time of the processor or increasing the frame rate at which frames are displayed. However, all of these approaches are limited by available technologies and a conflicting desire for a portable device to use as little power as possible so as to prolong battery life. When the drawing tool is being moved, the time lag is evidenced as a position lag. The faster the drawing tool movement, the greater the lag in position. The lag is undesirable and does not occur with conventional writing or drawing using a typical writing tool such as a pen or marker. It would therefore be desirable to provide an expedient for reducing the position lag of a computerized input tool such as a stylus.

### BRIEF DESCRIPTION OF THE DRAWINGS

Example embodiments of the present disclosure will be described below with reference to the included drawings such that like reference numerals refer to like elements and in which:

FIG. 1 is a diagram of a known drawing system.

FIG. 2 is diagram of computer drawing system, in accordance with some embodiments of the present disclosure.

FIG. 3 is a block diagram of circuit of a host electronic device, in accordance with some embodiments.

FIG. 4 is a diagrammatic representation of an image frame buffer, in accordance with some embodiments of the disclosure.

FIG. 5 is a flowchart of a method for reducing position lag, in accordance with some embodiments of the disclosure.

FIG. 6 is a diagram of a drawing system, in accordance with some embodiments of the present disclosure.

FIG. 7 is a diagram of an example line rendered by a computer drawing application, in accordance with some embodiments of the present disclosure.

FIG. 8 is a diagram of a further example line rendered by a computer drawing application, in accordance with some embodiments of the present disclosure.

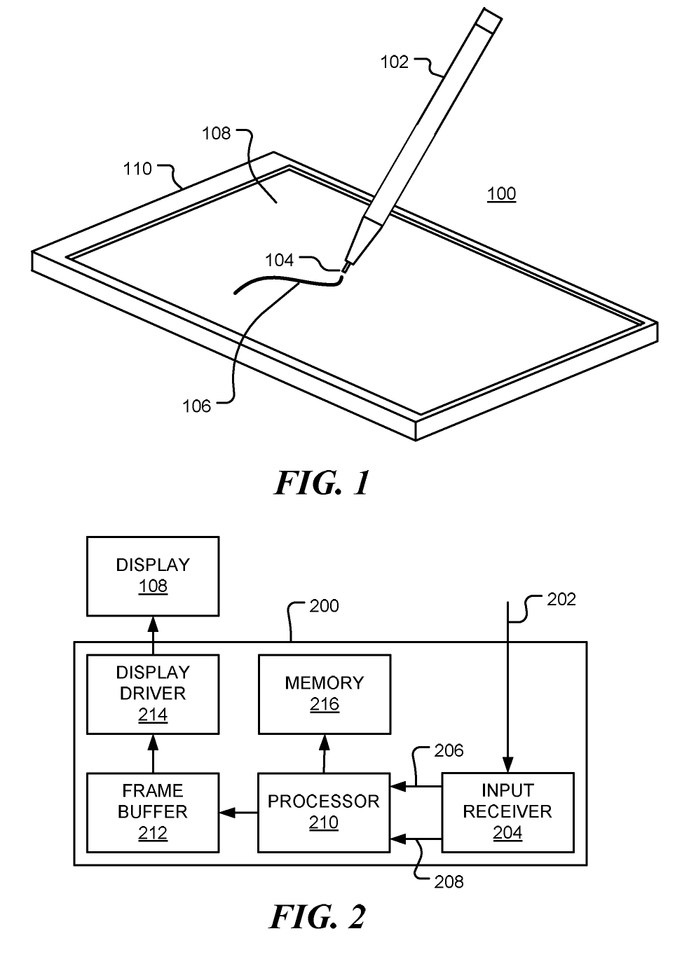

### DETAILED DESCRIPTION

For simplicity and clarity of illustration, reference numerals may be repeated among the figures to indicate corresponding or analogous elements. Numerous details are set forth to provide an understanding of the example embodiments described herein. The example embodiments may be practiced without these details. In other instances, well-known methods, procedures, and components have not been described in detail to avoid obscuring the example embodiments described. The description is not to be considered as limited to the scope of the example embodiments described herein.

The present disclosure relates to a computer drawing system having reduced position lag. A sequence of first and second position coordinates of a drawing tool position is received and processed, and utilizing this sequence, a future position of the drawing tool is predicted. An image frame is produced dependent upon the predicted position of the drawing tool and then output for rendering on a display screen. Similarly, the image frame may be dependent upon a predicted trajectory of the drawing tool.

FIG. 2 is diagram of computer drawing system 100 in accordance with some embodiments of the present disclosure. A pen-like stylus 102 has a tip 104 that causes an image, such as a line 106 to be drawn on a display screen 108 of a host electronic device 110. The host electronic device 110 may be, for example, a laptop computer, tablet computer (tablet), mobile phone, personal digital assistant (PDA), display screen, or other portable or non-portable electronic device. The position of the drawing tool may be determined by any of a variety of techniques known to those of ordinary skill in the art. In the embodiment shown, the line 106 follows the trajectory of the drawing tool as it moves across the surface of the screen.

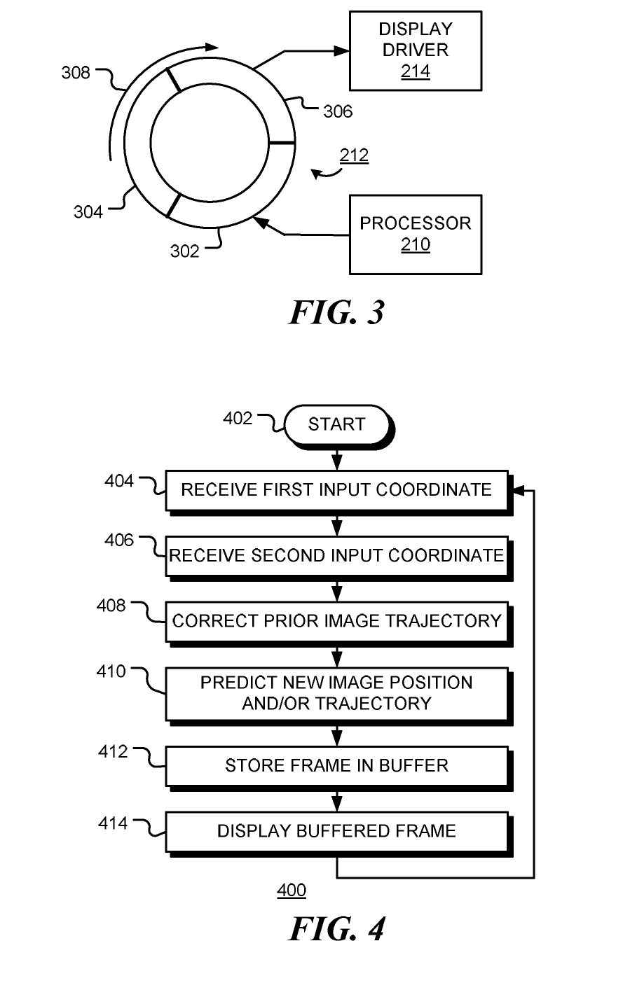

FIG. 3 is a block diagram of circuit 200 of a host electronic device in accordance with some embodiments. In operation, an input 202 dependent upon the drawing tool position is provided to an input receiver 204 that determines a first drawing tool coordinate 206, such as a horizontal or X position coordinate, and a second drawing tool coordinate 208, such as a vertical or Y position coordinate. The first and second drawing tool coordinates may be obtained by measuring both coordinates simultaneously, or the coordinates may be measured sequentially with the first coordinate measured at a first time and the second coordinate measured at a second time. In the latter approach, the first and second coordinates may correspond to different drawing tool positions when the drawing tool is moving. The first and second drawing tool coordinates are input to a processor 210, such as, for example, a programmed processor, where they are used to modify an image frame to be rendered on the display screen 108. For example, the coordinates may be processed to adjust the values of display screen pixels in proximity of the drawing tool tip. In particular, the first and second drawing tool coordinates may be employed to determine the position and/or trajectory of an image, such as a line or shape, rendered on the display screen 108. In one embodiment, consecutive image frames are buffered in a frame buffer 212. At a given time, a first frame of the frame buffer is being updated by the processor, a second frame is ready for display and third frame is being accessed for display. Each consecutive frame of pixel values, including the pixel values modified dependent upon the drawing tool position, is loaded into the first frame buffer 212. The third frame of the frame buffer is accessed by a display driver 214, such as a computer graphics circuit, that, in turn, causes the image to be displayed on the display screen 108. Once the display screen has been refreshed, the frame buffer is advanced and next frame in the frame buffer is accessed to produce the next image on the display screen. A sequence of drawing tool coordinates may be stored in a memory 216 that is operatively coupled to the processor 210.

The use of a frame buffer introduces a lag between when new drawing tool position coordinates are received and when they are accessed from the frame buffer. For example, if the frame rate is 60 Hz, a new image is produced every 16⅔ milliseconds, so a frame buffer of length three introduces a lag of approximately 50 milliseconds. For a drawing tool moving at 1 m/s, the corresponding position lag is 50 mm. The position lag increases as the speed at which the drawing tool is moved relative to the screen increases.

In order to simulate physical, non-computer drawing or writing, it is desirable that the image is displayed on the display screen as close as possible to the tip of the drawing tool.

One embodiment of the present disclosure relates to a system having an input receiver operable to receive input from a drawing tool, such as a stylus or touch screen, and to provide first and second position coordinates of the drawing tool to a processor. The processor determines a predicted position of the drawing tool and produces an image frame dependent upon the predicted position of the drawing tool. The image frame is stored in a frame buffer. A display driver retrieves image frames from the frame buffer and renders the image frames on a display screen.

The processor may predict the position of the drawing tool a time T in the future, where T is dependent upon a delay introduced by the frame buffer. Also, the processor may determine a predicted trajectory of the drawing tool. This enables the predicted trajectory to be rendered as line, for example, on the display screen.

FIG. 4 is a diagrammatic representation of a triple frame buffer 212 in accordance with some embodiments of the disclosure. The triple frame buffer 212 comprises frame memories 302, 304 and 306 that are accessed in a cyclic manner as indicated by the arrow 308. Thus, in a first frame period, memory 302 is being filled by the processor 210, memory 304 contains the next image to be displayed and memory 306 contains the image currently being accessed by display driver 214. In the next frame period, memory 304 is accessed by the device drive 214, and when memory processor 210 has filled memory 302 it begins filling memory 306. This process continues in a cyclic manner. The frame buffer may contain fewer or more frame memories than shown in FIG. 4. For example, double buffering may be used, although the program may have to wait until the next frame is completely loaded into the buffer before rendering of that frame can begin. This can result in less smooth rendering of animations, for example.

One embodiment of the present disclosure relates to a method for reducing position lag between a drawing tool position on a display screen and an image rendered on the display screen. First and second coordinates of the drawing tool position are received at first and second times, respectively. A predicted position, having first and second predicted coordinates, is determined dependent upon the first and second drawing tool position coordinates. At a third time, subsequent to the first and second times, an image is rendered on the display screen dependent upon the predicted position. The first and second predicted coordinates of the predicted position may also be dependent upon first and second drawing tool coordinates prior to the first and second times.

In one embodiment, the image is a line, in which case the line rendered along a predicted drawing tool trajectory terminates at the predicted position. As new drawing tool positions become available, the rendered image may be adjusted or corrected. In a further embodiment, the image comprises an image of an object that is rendered at the predicted position.

The first and second predicted coordinates of the predicted position may be dependent upon a time lag T between the time when the first and second drawing tool coordinates are received and the third time.

The first and second coordinates of the drawing tool position may be received from a stylus, or a touch screen, for example.

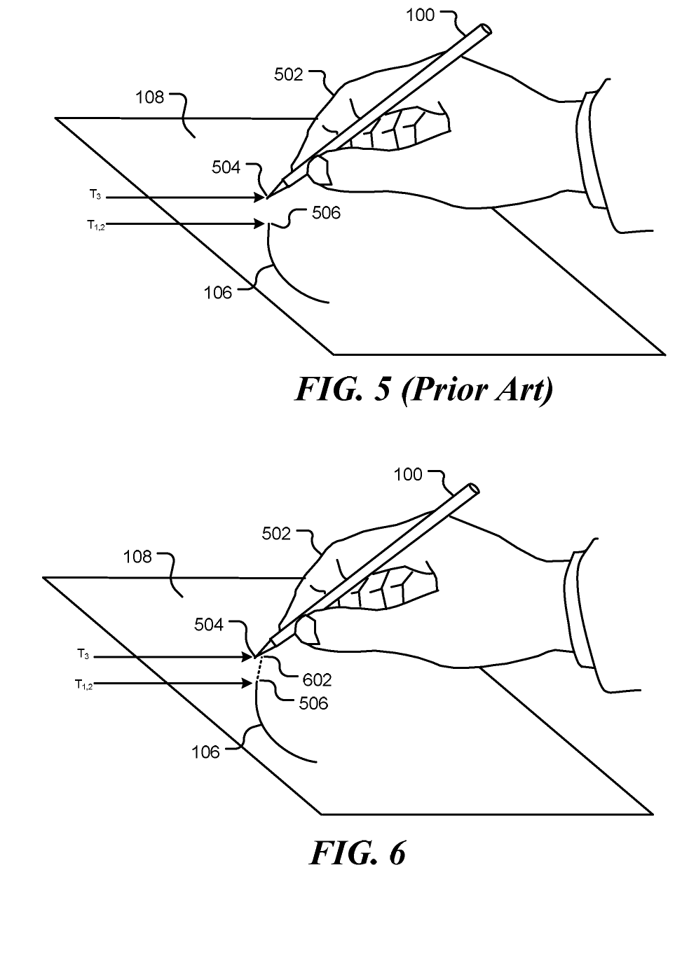

FIG. 5 is a flowchart of a method 400 for reducing position lag between a drawing tool position on a display screen and an image position on the display screen. Referring to FIG. 5, the method begins at start block 402. At a first time (T₁), indicated by block 404, a first coordinate of the drawing tool position is received. At a second time (T₂), indicated by block 406, a second coordinate of the drawing tool position is received. The first and second times may be the same or different. Optionally, at block 408, a previous trajectory of an image in the frame is corrected, dependent upon the first and second drawing tool coordinates. This may be appropriate, for example, when a line is being drawn since the line follows the prior trajectory. However, when the drawing tool is being used to drag an image of an object across the screen and the trajectory is not shown, there is no need to correct the trajectory. At the third time (T₃), indicated by block 410, a new image position and/or trajectory at a third time is predicted, dependent upon the first and second drawing tool position coordinates. At the third time, indicated by block 412 a new frame, dependent upon the predicted image position and/or trajectory, is stored in the frame buffer. At block 414 a frame from the frame buffer is rendered on the display screen. It is noted that since the third time is subsequent to the first and second times, the trajectory of the image displayed on the screen is, at least in part, a prediction of the image trajectory. In this way, the position lag is reduced.

In one embodiment, the image position and/or trajectory, at the third time, is further dependent upon first and second drawing tool coordinates prior to the first and second times.

In operation there is a time lag T between the time when the later of the first and second drawing tool coordinates is received and the third time (T₃) when a new image is rendered on the screen. In one embodiment, the prediction of new drawing tool position is dependent upon the lag time T. That is, the new image coordinates are a prediction of the drawing tool tip position a time T in the future. If the first and second coordinates are not received at the same time, the prediction may further depend upon the time difference between receipt of the first and second coordinates. Equivalently, the prediction is dependent upon the difference between the third and first times and the difference between the third and second times. The time lag T may also depend upon the frame rate and the length of the frame buffer.

In one embodiment, the predicted image position and/or trajectory comprises a prediction of the drawing tool position and/or trajectory between one and four frame periods in the future. The prediction time may be selected dependent upon the frame rate and upon the number of frames in the frame buffer.

FIG. 6 is a diagram of a drawing system in accordance with some embodiments of the present disclosure, depicting a drawing tool 100 being moved by a user 502 across the surface of a display screen 108. Displacement of the drawing tool causes a line 106 to be rendered on the display screen 108, with the line 106 following the trajectory of the drawing tool 100. In the embodiment shown, the drawing tool is a stylus. However, other drawing tools may be used, such as, for example, a finger of the user 502. At a time denoted by T₃, the tip of the drawing tool 100 is at a position 504 on the screen 108. Position 506, which corresponds to the position of the drawing tool 100 at the earlier time T_{1,2}, is the latest known drawing tool position used in the rendering. Here it is assumed, for simplicity, that both coordinates of the drawing tool are received at the same time. However, the coordinates may be received consecutively. In accordance with the present disclosure, the line 106 is extended from position 506 to a predicted drawing tool position 602. For the purpose of explanation, the extension to the line is shown as dotted rather than solid; however, in practice, the extension to the line may have the same properties as the line 106.

In one embodiment, the extension to the line 106 may be a straight line. In a further embodiment, the line follows a predicted trajectory of the drawing tool from time T_{1,2} to time T₃ and may be curved or straight.

It is noted that the trajectory may be not always be predicted exactly, so the positions 504 and 602 may not coincide. In one embodiment, later renderings of the extension to line 106 may be corrected or adjusted dependent upon later measurements of the drawing tool position.

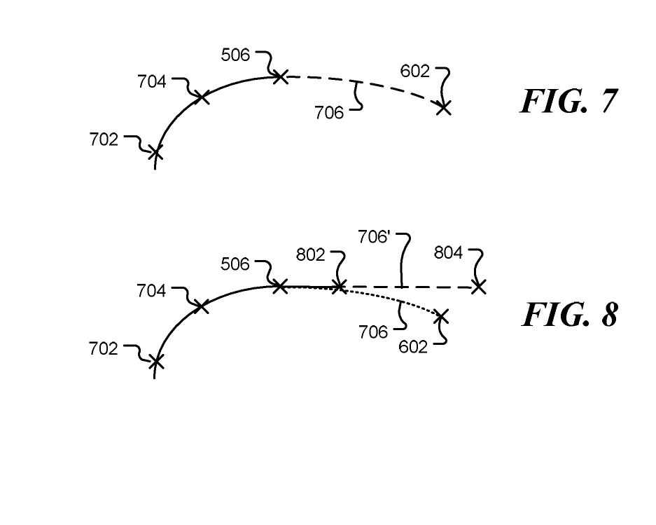

FIG. 7 is a diagram of an example line rendered by a computer drawing application, in accordance with some embodiments of the present disclosure. The line comprises a segment 106, that is computed dependent upon measured drawing tool positions 702, 704 and 506, and a segment 706 that is predicted dependent on the measured drawing tool positions. The segment 706 ends at position 602 that corresponds to a predicted drawing tool position a time T after the tools was at position 506. The line segment 706 may correspond to a predicted trajectory of the drawing tool. Again, for the purpose of explanation, the predicted line segment 706 is shown as dotted rather than solid; however, in practice the extension to the line may have the same properties as the line segment 106 so that is appears continuous with the line segment 106.

FIG. 8 is a diagram of an example line rendered by a computer drawing application, in accordance with some embodiments of the present disclosure. The rendering is shown one frame later than the rendering shown in FIG. 7. In FIG. 8, a new drawing tool position 802 has become available, and the segment of line between positions 506 and 802 is now drawn based on measurements rather than predictions. In addition, the line segment 706′ between position 802 and position 804 is predicted based upon prior positions including position 802. The line segment 706 between points 506 and 602 is no longer rendered. Instead, segment 706′ is rendered, since it is likely that the new prediction drawing tool position 804 is closer than prior position 602 to the actual drawing tool position.

The line segments 706 and 706′ may be determined using known algorithms for trajectory prediction. Such algorithms are commonly used in applications such as military target tracking.

In one embodiment, the predicted trajectory comprises a straight line having the same gradient at the last region of known trajectory. For example, if the last measured drawing tool position has Cartesian coordinates {x_{N},y_{N}} and the previous position has coordinates {x_{N-1},y_{N-1}}, the trajectory may have coordinates

$$\{ {x}_{N} + \frac{{x}_{N} - {x}_{N}}{{T}_{frame}} t , {y}_{N} + \frac{{y}_{N} - {y}_{N - 1}}{{T}_{frame}} t \} ,$$

where T_{frame} is the frame period and the parameter t denotes the time since the last measured position. The coordinates of the predicted trajectory are found by varying the parameter t between zero and the lag time T. For example, if a triple frame buffering is used, T might be set to approximately 3×T_{frame}.

In a further embodiment, the predicted trajectory has the same curvature and slope as the last region of known trajectory.

In a still further embodiment, the predicted trajectory is dependent upon a predicted the speed and/or acceleration of the drawing tool.

Various trajectory prediction algorithms may be used without departing from the scope of the present disclosure.

The trajectory prediction algorithm may be implemented by processor 210 depicted in FIG. 3. In one embodiment, the processor is a programmed processor that is operable to execute a program of computer-executable instructions. These instructions may be stored in a non-transitory computer-readable medium.

In one embodiment, a non-transitory computer-readable medium has computer-executable instructions for receiving a sequence of first and second position coordinates of a drawing tool and determining, from the sequence of first and second position coordinates, a predicted position of the drawing tool. The medium has further instructions for producing an image frame dependent upon the predicted position of the drawing tool and outputting the image frame for rendering on a display screen.

The medium may also have instructions determining, from the sequence of first and second position coordinates, a predicted trajectory of the drawing tool, where the image frame is further dependent upon the predicted trajectory of the drawing tool.

In one embodiment, the computer-readable medium has computer-executable instructions for implementing a computer drawing application.

It will be appreciated that any module or component disclosed herein that executes instructions may include or otherwise have access to non-transient and tangible computer readable media such as storage media, computer storage media, or data storage devices (removable or non-removable) such as, for example, magnetic disks, optical disks, or tape data storage. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any application or module herein described may be implemented using computer readable/executable instructions that may be stored or otherwise held by such computer readable media.

The implementations of the present disclosure described above are intended to be examples only. Those of skill in the art can effect alterations, modifications and variations to the particular example embodiments herein without departing from the intended scope of the present disclosure. Moreover, selected features from one or more of the above-described example embodiments can be combined to create alternative example embodiments not explicitly described herein.

The present disclosure may be embodied in other specific forms without departing from its spirit or essential characteristics. The described example embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method for reducing position lag between a drawing tool position on a display screen and an image rendered on the display screen, the method comprising:
at a first time, receiving a first coordinate of the drawing tool position;
at a second time, receiving a second coordinate of the drawing tool position;
predicting, dependent upon the first and second drawing tool position coordinates, a predicted position having first and second predicted coordinates;
at a third time, subsequent to the first and second times, rendering an image on the display screen dependent upon the predicted position,
the predicted position dependent upon a delay introduced by a frame buffer operable to store one or more image frames to be rendered.

2. The method in accordance with claim 1, wherein the first and second predicted coordinates of the predicted position are further dependent upon first and second drawing tool coordinates prior to the first and second times.

3. The method in accordance with claim 1, wherein the image comprises a line, the method further comprising:
predicting a trajectory of the line ending at the predicted position; and
rendering the line ending at the predicted position.

4. The method in accordance with claim 1, further comprising:
adjusting the image rendered at the third time dependent upon first and second coordinates of the drawing tool position received subsequent to the first and second times.

5. The method in accordance with claim 1, wherein the first and second predicted coordinates of the predicted position are further dependent upon a time lag T between the first and second times when the first and second drawing tool coordinates are received and the third time.

6. The method in accordance with claim 1, wherein receiving the first and second coordinates of the drawing tool position comprises:
receiving first and second coordinates of a stylus position.

7. The method in accordance with claim 1, wherein the display screen comprises a touch screen, and wherein receiving the first and second coordinates of the drawing tool position comprises:
receiving first and second coordinates of a touch position on the display screen.

8. The method in accordance with claim 1, wherein the image comprises an object image, the method further comprising:
rendering the object image at the predicted position.

9. The method in accordance with claim 1, wherein the first and second predicted coordinates of the predicted position are further dependent upon an estimated speed of the drawing.

10. A non-transitory computer-readable medium having computer-executable instructions, which when executed by a processor, cause the processor to:
receive a sequence of first and second position coordinates of a drawing tool on a display screen;
determine, from the sequence of first and second position coordinates, a predicted position of the drawing tool;
produce an image frame dependent upon the predicted position of the drawing tool, the predicted position dependent upon a delay introduced by a frame buffer operable to store one or more image frames to be rendered; and
output the image frame for rendering on the display screen.

11. The non-transitory computer-readable medium in accordance with claim 10, having further computer-executable instructions, which when executed by the processor, cause the processor to:
determine, from the sequence of first and second position coordinates, a predicted trajectory of the drawing tool,
where the image frame is further dependent upon the predicted trajectory of the drawing tool.

12. The non-transitory computer-readable medium in accordance with claim 10, having further computer-executable instructions, which when executed by the processor, cause the processor to implement a computer drawing application.

13. A system comprising:
an input receiver operable to receive input from a drawing tool and to provide first and second position coordinates of the drawing tool; and
a processor, operable to receive the first and second position coordinates, determine a predicted position of the drawing tool from the first and second coordinates, and produce an image frame dependent upon the predicted position of the drawing tool, the predicted position dependent upon a delay introduced by a frame buffer operable to store one or more image frames to be rendered.

14. The system in accordance with claim 13, further comprising:
a stylus, operable to provide input to the input receiver.

15. The system in accordance with claim 13, further comprising:
a frame buffer operable to store one or more image frames produced by the processor;
a display screen; and
a display driver, operable to retrieve an image frame from the frame buffer and to render the image frame on the display screen.

16. The system in accordance with claim 15, wherein the display screen comprises a touch screen.

17. The system in accordance with claim 15, wherein the processor is operable to predict the position of the drawing tool a time T in the future, where T is dependent upon a delay introduced by the frame buffer.

18. The system in accordance with claim 15, wherein the processor is further operable to determine a predicted trajectory of the drawing tool, and wherein the image frame is dependent upon the predicted trajectory of the drawing tool.

19. A portable electronic device comprising the system of claim 15.

20. An electronic device, comprising:
a display screen configured to receive input from a drawing tool that can be moved along a trajectory relative to the display screen;
a processor configured to receive first and second position coordinates along the trajectory, determine a predicted position of the drawing tool from the first and second coordinates, and produce an image frame dependent upon the predicted position of the drawing tool;
a frame buffer operable to store one or more image frames produced by the processor, the predicted position dependent upon a delay introduced by the frame buffer operable to store one or more image frames to be rendered; and
a display driver operable to retrieve an image frame from the frame buffer and to render the image frame on the display screen predicted position of the drawing tool.
